(19) United States
(12) Patent Application Publication
(10) Pub. No.: US 2021/0162966 A1
(43) Pub. Date: Jun. 3, 2021

(54) MOTOR VEHICLE BRAKE SYSTEM, METHOD FOR OPERATING SAME AND CONTROL APPLIANCE THEREFOR

(71) Applicant: ZF Active Safety GmbH, Koblenz (DE)

(72) Inventor: Andreas Passmann, Hilgert (DE)

(73) Assignee: ZF Active Safety GmbH, Koblenz (DE)

(21) Appl. No.: 16/650,233

(22) PCT Filed: Jul. 24, 2018
(86) PCT No.: PCT/EP2018/070015

§ 371 Date: Mar. 24, 2020

(30) Foreign Application Priority Data
Sep. 25, 2017 (DE) 10 2017 008 948.5

(51) Int. Cl. B60T 8/1763; B60T 17/22; B60T 13/66; B60T 8/94; B60T 8/1764; B60T 8/172; B60T 8/171

(52) U.S. Cl. CPC B60T 8/17636; B60T 8/1755; B60T 13/662; B60T 8/94; B60T 8/1764; B60T 8/172; B60T 8/171; B60T 2270/402; B60T 2270/406; B60T 2270/10; B60T 2210/124; B60T 2250/03; B60T 2220/00; B60T 2270/30; B60T 17/221

(57) ABSTRACT

A motor vehicle brake system is specified. The brake system comprises a driving dynamics regulation system, which is designed to carry out a wheel-specific regulating intervention on each of a plurality of vehicle wheels, and an electrically controllable actuator, which is designed to generate or boost a service brake force. The brake system further comprises a control, which is designed, in the event of an identified loss of function of the driving dynamics regulation system, to select one of at least two vehicle wheels on which a regulating intervention by the driving dynamics regulation system would be required and to electrically control the actuator on the basis of a regulating intervention determined for the selected vehicle wheel.

### CROSS-REFERENCE TO RELATED APPLICATION

This application is a national stage of International Application No. PCT/EP2018/070015, filed Jul. 24, 2018, the disclosure of which is incorporated herein by reference in its entirety, and which claimed priority to German Patent Application No. 102017008948.5, filed Sep. 25, 2017, the disclosure of which is incorporated herein by reference in its entirety

### TECHNICAL FIELD

The present disclosure relates to the field of motor vehicle brake systems in general. Specifically, the operation of a motor vehicle brake system in the event of failure of a driving dynamics regulation system is described.

### BACKGROUND

Known hydraulic motor vehicle brake systems, which are configured as brake-by-wire (BBW) systems or are equipped with an electric brake boost (EBB) system, comprise an electrically controllable actuator which, in service brake mode, generates a hydraulic pressure on the wheel brakes of the motor vehicle or boosts a hydraulic pressure generated by the driver. To this end, deceleration of a vehicle, requested by the driver via a brake pedal, is sensor-detected and converted into a control signal for the electrically controllable actuator.

Brake systems of this type normally also comprise a master cylinder which can be mechanically actuated by means of the brake pedal and via which hydraulic fluid can likewise be delivered to the wheel brakes. The master cylinder, which can be actuated by means of the brake pedal, produces a redundancy in relation to the electrically controllable hydraulic pressure generator of the BBW or EBB system, which is vital for reasons of operational safety. Motor vehicle brake systems for autonomous or partially autonomous driving are designed with redundancy, especially since the driver is not necessarily located inside the vehicle (e.g. in remote-controlled parking—RCP—mode).

Modern brake systems furthermore comprise a driving dynamics regulation system (also known as electronic stability control, ESC), which comprises, for example, one or more functions such as anti-slip regulation (ASR), an anti-lock brake system (ABS) or an electronic stability program (ESP). There are demands for the driving dynamics regulation system to be designed with redundancy. In other words, at least rudimentary driving dynamics regulation should still be possible in the event of a loss of function of the driving dynamics regulation system to enable the vehicle stability or the deceleration capacity to be at least partially maintained.

### SUMMARY

The present disclosure is based on the object of specifying a motor vehicle brake system which has a redundancy in the event of a loss of function of the driving dynamics regulation system.

According to a first aspect, a motor vehicle brake system is specified. The brake system comprises a driving dynamics regulation system, which is designed to carry out a wheel-specific regulating intervention on each of a plurality of vehicle wheels, and an electrically controllable actuator, which is designed to generate or boost a service brake force. The brake system further comprises a control, which is designed, in the event of an identified loss of function of the driving dynamics regulation system, to select one of at least two vehicle wheels on which a regulating intervention by the driving dynamics regulation system would be required in each case and to electrically control the actuator on the basis of a regulating intervention determined for the selected vehicle wheel.

The brake system can be a hydraulic, a pneumatic, a mechanical or a regenerative brake system. Combinations thereof are also conceivable (e.g. a hydraulic regenerative brake system).

The electrically controllable actuator can be part of an EBB system (for brake boosting) or a BBW system (for brake force generation). The actuator can comprise an electric motor and a transmission connected downstream of the electric motor. In a hydraulic brake system, a cylinder-piston arrangement or other device for hydraulic pressure generation can be connected downstream of the transmission.

In one realization, the brake system is configured as a BBW system, which comprises the actuator, and/or is equipped with an EBB system, which comprises the actuator. In one design, the brake system is provided with an electrically controllable vacuum brake booster, which functions as the actuator.

The BBW system can provide a constant mechanical decoupling of a brake pedal from a master cylinder of the brake system. This mechanical decoupling can be overridden in favor of mechanical push-through (PT) in the event of an error in the BBW system.

The EBB system (including the electrically controllable vacuum brake booster) cannot provide such a mechanical decoupling, or can only provide it in certain cases (e.g. with regenerative braking), wherein, in the case of the mechanical coupling, a force acting on the master cylinder by means of the brake pedal is boosted using the actuator.

The service brake force can be requested by a driver via a brake pedal. The service brake force can also be requested by a system for autonomous or partially autonomous driving. The service brake force is conventionally used for braking the moving vehicle and therefore differs functionally from the brake force generated by an emergency brake (e.g. an electric parking brake, EPB), for example.

The electrical control of the actuator on the basis of a regulating intervention determined for the selected vehicle wheel can comprise regulation on the basis of a parameter measured at the selected vehicle wheel. The measured parameter can also be used as a regulating variable. Such a parameter can be, for example, a wheel speed or a wheel velocity. Further or other parameters can be analyzed within the framework of the regulating intervention.

In one implementation, the control is designed to control the actuator on the basis of an anti-slip regulation intervention determined for the selected vehicle wheel. In the case of a hydraulic brake system, brake pressure regulation can take place for this purpose, which comprises, for example, pressure-decrease, pressure-build-up and pressure-holding phases.

According to one variant, the control is designed to select the vehicle wheel with the greatest slip. According to a further development, the control is designed to select the wheel with the (e.g. relatively) greatest slip, for which one or more further conditions are fulfilled. The further condition can refer, for example, to a particular vehicle side or a particular vehicle axle (e.g. front axle or rear axle). The further condition can additionally or alternatively refer to wheel-related roadway coefficients of friction. In such a further development, of all the vehicle wheels on which a regulating intervention by the driving dynamics regulation system would be required, it is not necessarily the wheel with the greatest absolute slip which is selected.

The control can be designed to analyze the roadway coefficients of friction associated with the vehicle wheels and to select the vehicle wheel on the basis of the roadway coefficient-of-friction analysis. The roadway coefficient of friction is also denoted by the Greek letter μ.

The control can therefore be designed to determine a high coefficient-of-friction side of the vehicle on the basis of the roadway coefficient-of-friction analysis and to select the vehicle wheel with the greatest slip on the high coefficient-of-friction side. The control can also be designed, when the roadway coefficients of friction at all vehicle wheels are each below a threshold value, to select the vehicle wheel with the greatest slip. The control can further be designed, when the roadway coefficients of friction at all vehicle wheels are each above a threshold value, to select a rear wheel. In the latter case, the control can be designed to carry out the regulating intervention on the selected rear wheel in such a way that, for the selected rear wheel, a coefficient-of-friction limit is prevented from being exceeded.

In general, the control can be designed to determine a yaw rate (e.g. by receiving a parameter indicating the yaw rate). In this case, the control can further be designed to carry out at least one of the following steps: select the vehicle wheel on the basis of the determined yaw rate and/or carry out the regulating intervention on the basis of the determined yaw rate.

In one variant, the control is designed to recognize oversteering on the basis of the yaw rate and to select a wheel on the inside of the turn or a rear wheel. The control can also be designed to determine understeering on the basis of the yaw rate and to select a wheel on the outside of the turn or a front wheel.

The control is, for example, further designed to also carry out the regulating intervention determined for the selected vehicle wheel on at least one non-selected vehicle wheel. In this case, the control can be designed, when carrying out the regulating intervention determined for the selected vehicle wheel on the at least one non-selected vehicle wheel, to permit locking of the at least one non-selected vehicle wheel.

In one implementation, the control is designed to identify a requirement for a regulating intervention on each of the at least two vehicle wheels. In this connection, the control can analyze one or more sensor-measured parameters and, on the basis of this analysis, identify whether or not a regulating intervention is required on a particular vehicle wheel. The regulating intervention can then be carried out with continued analysis of the one or more parameters (which then serve e.g. as regulating variable(s)).

The control can be designed to identify the regulating-intervention requirement on the basis of slip recognition for the respective vehicle wheel. In general, the control can be designed to identify the regulating-intervention requirement on the basis of at least one parameter measured at the respective vehicle wheel (e.g. wheel speed or wheel velocity). Additionally or alternatively, the control can be designed to identify the regulating-intervention requirement on the basis of at least one of the following parameters: yaw rate, steering angle, lateral acceleration, longitudinal acceleration, wheel speed, wheel velocity.

The control can further be designed to identify the loss of function of the driving dynamics regulation system. The loss of function can be identified by receiving an error signal or (alternatively) monitoring the driving dynamics regulation system. The loss of function can be caused, for example, by failure of a hydraulic, mechanical or electrical component of the driving dynamics regulation system. This includes a pump, valves etc.

The brake system can further comprise a control device, which is associated with the driving dynamics regulation system, and a second control device, which is associated with the electrically controllable actuator, wherein the control is implemented in the second control device. The second control device can be a control device for an electric brake booster or for a brake-by-wire system or for autonomous or partially autonomous driving.

A second aspect relates to a method for operating a motor vehicle brake system having a driving dynamics regulation system, which is designed for carrying out a wheel-specific regulating intervention on each of a plurality of vehicle wheels, and an electrically controllable actuator, which is designed to generate or boost a brake force. The method comprises, in the event of an identified loss of function of the driving dynamics regulation system, selecting one of at least two vehicle wheels on which a regulating intervention by the driving dynamics regulation system would be required in each case, and electrically controlling the actuator on the basis of a regulating intervention determined for the selected vehicle wheel.

The method can further comprise method steps which correspond to the functions of the control described here.

Likewise described control device or system made up of a plurality of control devices, comprising at least one processor and at least one memory, wherein the at least one memory contains program code for carrying out the method presented here when it is run on the at least one processor. The control device or system made up of a plurality of control devices is an exemplary implementation of the control described here.

### BRIEF DESCRIPTION OF THE DRAWINGS

Further aspects, details and advantages of the present disclosure are revealed in the description below of exemplary embodiments with reference to the figures, which show:

FIG. 1 an exemplary embodiment of a motor vehicle brake system;

FIG. 2 an exemplary embodiment of a control device system for the brake system according to FIG. 1; and

FIG. 3 a flow chart of an exemplary embodiment of a method for operating the brake system according to FIG. 1.

### DETAILED DESCRIPTION

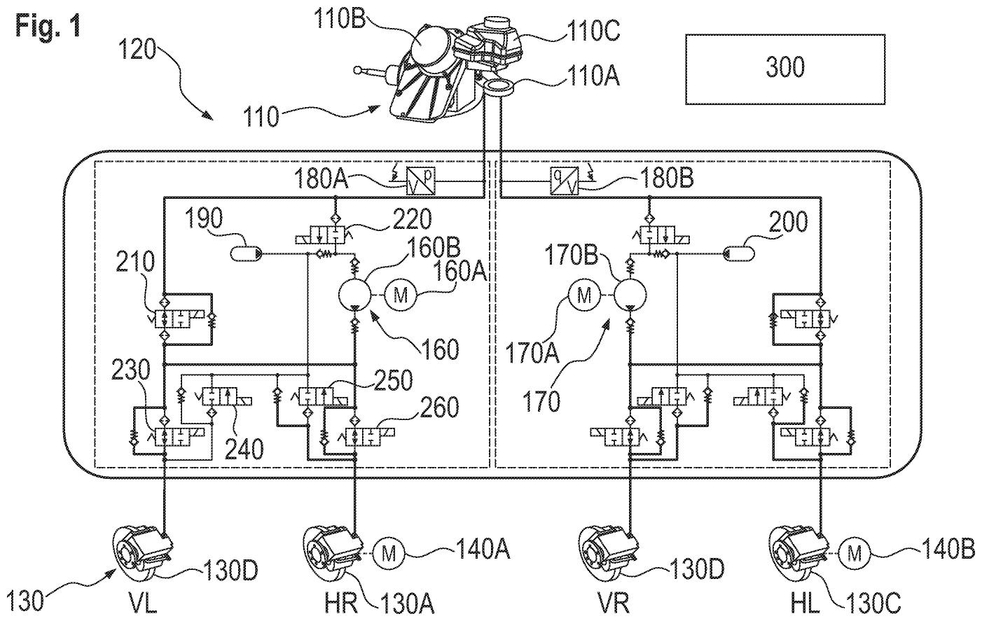

The hydraulic circuit diagram of an exemplary embodiment of a hydraulic motor vehicle brake system 100 is shown in FIG. 1. It should be pointed out that the present solution is not restricted to a hydraulic brake system, but will merely be discussed by way of example with the aid of a hydraulic brake system.

The brake system 100 comprises an assembly 110 for hydraulic pressure generation, which can be coupled to a brake pedal (not shown), and a hydraulic control assembly 120 (also known as a hydraulic control unit, HCU) with two separate brake circuits I. and II. The brake system 100 further comprises four wheel brakes. Two of the four wheel brakes 130 are associated with the brake circuit I., whilst the two wheel brakes 130 are associated with the brake circuit II. The association of the wheel brakes 130 with the brake circuits I. and II. takes place according to a diagonal allocation in such a way that the wheel brakes 130A and 130B at the right rear wheel (HR) and at the left front wheel (VL) are associated with the brake circuit I., whilst the wheel brakes 130C and 130D at the left rear wheel (HL) and at the right front wheel (VR) are associated with the brake circuit II. Any other allocation of the wheel brakes 130 to the brake circuit I. and II. would be likewise conceivable.

In the present exemplary embodiment, the brake system 100 further comprises an optional electric parking brake (EPB) with two electromechanical actuators 140A, 140B which can be electrically controlled separately from one another. In FIG. 1, the actuators 140A, 140B are each merely indicated in the form of an electric motor. It goes without saying that the actuators 140A, 140B comprise further components, for example a transmission, via which the actuators 140A, 140B act for example on brake cylinders.

The two actuators 140A, 140B are associated with different wheel brakes of the four wheel brakes 130. Specifically, the actuator 140A is associated with the wheel brake 130A of the right rear wheel (HR), whilst the actuator 140B is associated with the wheel brake 130C of the left rear wheel (HL). Of course, in other variants, the two actuators can also be associated with the wheel brakes 130B, 130D of the right front wheel (VR) and the left front wheel (VL).

The assembly 110 for hydraulic pressure generation comprises a master cylinder 110A and can be operated according to the EBB and/or the BBW principle. This means that, incorporated in the assembly 110, there is an electrically controllable actuator in the form of a hydraulic pressure generator 110B which is designed to boost or generate a hydraulic pressure for at least one of the two brake circuits I. and II. This hydraulic pressure generator 110B comprises an electric motor, which acts directly or indirectly on the master cylinder 110A for hydraulic pressure generation via a mechanical transmission (not shown). Indirect action can take place for example hydraulically (for instance, in that the transmission acts on a plunger arrangement whereof the output is hydraulically coupled to an input of the master cylinder 110A).

The HCU 120 comprises a driving dynamics regulation system (also referred to as an ESC system) for carrying out regulating interventions on the wheel brakes 130, which, in the present example, is designed with two circuits. In other exemplary embodiments, the driving dynamics regulation system can also be designed in a known manner, with one circuit.

Specifically, the two-circuit driving dynamics regulation system according to FIG. 1 comprises a first electrically controllable hydraulic pressure generator 160 in the first brake circuit I. and a second electrically controllable hydraulic pressure generator 170 in the second brake circuit II. Each of the two hydraulic pressure generators 160, 170 comprises an electric motor 160A, 170B and a pump 160B, 170B which can be actuated by the electric motor 160A, 170B. Each of the two pumps 160B, 170B can be designed as a multi-piston pump, as a gear pump or in another manner. Each pump 160B, 170B has a blocking action contrary to its delivery direction, as illustrated with the aid of the blocking valves at the output and input of the pumps 160B, 170B. Since the speed of each of the electric motors 160A, 170A is adjustable, the delivery quantity of each of the pumps 160B, 170B can also be adjusted by controlling the associated electric motor 160A, 170A accordingly.

The two electric motors 160A, 170A—and therefore the two hydraulic pressure generators 160, 170—can be controlled independently of one another. This means that each of the two hydraulic pressure generators 160 and 170 can build up a hydraulic pressure independently of the other hydraulic pressure generator 170 or 160 in the respective brake circuit I. or II. This redundancy is advantageous in relation to safety considerations.

The brake system 100 operates by means of a hydraulic fluid, which is partly stored in three reservoirs 110C, 190, 200. Whilst the reservoir 110C is an unpressurized reservoir, which forms part of the assembly 110, the other two reservoirs 190, 200 are each integrated as pressure accumulators (e.g. as low pressure accumulators, LPA) in one of the two brake circuits I., II. The two hydraulic pressure generators 160 and 170 are each capable of sucking hydraulic fluid out of the associated reservoir 190 or 200 or out of the central reservoir 110C.

The reservoir 110C has a greater capacity than each of the two reservoirs 190, 200. However, the volume of the hydraulic fluid stored in each of the two reservoirs 190, 200 is at least sufficient to enable a vehicle to also be brought safely to a stop in the event of a required brake pressure regulation on one or more of the wheel brakes 130 (e.g. in the event of ABS-assisted emergency braking).

The brake circuit I. comprises a hydraulic pressure sensor 180A, which is arranged on the input side of the brake circuit I. in the region of its interface with the assembly 110. The signal of the hydraulic pressure sensor 180A can be analyzed in association with a control of the hydraulic pressure generator 110B integrated in the assembly 110 and/or the hydraulic pressure generator 160 integrated in the brake circuit I. The analysis and control takes place by means of a control device system 300 shown merely schematically in FIG. 1. A further hydraulic pressure sensor 180B is integrated accordingly in the brake circuit II.

As shown in FIG. 1, the two brake circuits I. and II. are constructed identically in terms of the components integrated therein and the arrangement of these components. For this reason, only the construction and the mode of operation of the first brake circuit I. will be explained in more detail below.

In the brake circuit I., a plurality of valves which can be actuated by electromagnets are provided, which, in the unactuated, i.e. electrically non-controlled state, assume the basic positions illustrated in FIG. 1. In these basic positions, the valves couple the assembly 110, in particular the master cylinder 110A, to the wheel brakes 130. Therefore, even in the event of a loss of function (e.g. a failure) of the energy supply and an associated failure of the hydraulic pressure generator 110B, the driver can still build up a hydraulic pressure on the wheel brakes 130 by means of the brake pedal acting on the master cylinder 110A. However, in the case of an EBB implementation, this hydraulic pressure is then not boosted or, in the case of a BBW implementation, a mechanical coupling of the brake pedal to the master cylinder 110A takes place (push-through, PT, mode). In BBW mode, on the other hand, the master cylinder 110A is fluidically decoupled from the brake circuit I. in a known manner.

The multiplicity of valves comprises two 2/2-way valves 210, 220, which permit an uncoupling of the two wheel brakes 130A and 130B from the assembly 110. Specifically, the valve 210 is provided to uncouple the wheel brakes 130A, 130B from the assembly 110 in the electrically controlled state when, by means of the hydraulic pressure generator 160, a regulating intervention is carried out on at least one of the two wheel brakes 130A, 130B. In its electrically controlled state, the valve 220 enables hydraulic fluid to be sucked or fed out of the reservoir 110C (e.g., in the case of a sustained regulating intervention, if the reservoir 190 is to be emptied completely). A decrease in pressure at the wheel brakes 130A, 130B is further possible in this electrically controlled state, in that a return flow of hydraulic fluid from the wheel brakes 130A, 130B into the unpressurized reservoir 110C is enabled.

The hydraulic connection of the wheel brakes 130A, 130B to the assembly 110 and the hydraulic pressure generator 160 is determined by four 2/2-way valves 230, 240, 250, 260 which, in the unactuated, i.e. electrically non-controlled state, assume the basic positions illustrated in FIG. 1. This means that the two valves 230 and 260 each assume their throughflow position, whilst the two valves 240 and 250 each assume their blocking position. The two valves 230 and 240 form a first valve arrangement associated with the wheel brake 130B, whilst the two valves 250 and 260 form a second valve arrangement associated with the wheel brake 130A.

As explained below, the two valves 210 and 220, the two valve arrangements 230, 240 and 250, 260 and the hydraulic pressure generator 160 are each designed to be controlled for wheel brake pressure-regulating interventions on the respective wheel brake 130A, 130B. The control of the two valves 210 and 220, the two valve arrangements 230, 240 and 250, 260 and the hydraulic pressure generator 160 within the framework of the regulating interventions takes place by means of the control device system 300. The control device system 300 implements, for example, the wheel brake pressure-regulating interventions of driving dynamics regulation, wherein the driving dynamics regulation according to the present disclosure also includes an anti-lock brake system (ABS) and/or anti-slip regulation (ASR) and/or an electronic stability program (EPB) and/or brake pressure regulation for adaptive cruise control (ACC).

Anti-lock regulation involves preventing the wheels from locking during braking. To this end, it is necessary to modulate the hydraulic pressure in the wheel brakes 130A, 130B individually. This takes place by adjusting successively alternating pressure-build-up, pressure-holding and pressure-decrease phases, which are realized by suitably controlling the valve arrangements 230, 240 and 250, 260 associated with the two wheel brakes 130B and 130A and possibly the hydraulic pressure generator 160.

During a pressure-build-up phase, the valve arrangements 230, 240 and 250, 260 each assume their basic position, so that an increase in the brake pressure in the wheel brakes 130A, 130B (as in the case of BBW braking) can take place by means of the hydraulic pressure generator 160. For a pressure-holding phase at one of the wheel brakes 130B and 130A, only the valve 230 or 260 is controlled, i.e. brought into its blocking position. Since control of the valve 240 or 250 does not take place in this case, it remains in its blocking position. The corresponding wheel brake 130B or 130A is thus hydraulically uncoupled so that a hydraulic pressure applied in the wheel brake 130B or 130A is held constant. In a pressure-decrease phase, both the valve 230 or 260 and the valve 240 or 250 are controlled, i.e. the valve 230 or 260 is brought into its blocking position and the valve 240 or 250 is brought into its throughflow position. Hydraulic fluid can therefore flow out of the wheel brake 130B or 130A in the direction of the reservoir 110C and 190 in order to lower a hydraulic pressure applied in the wheel brake 130A or 130B.

Other regulating interventions in normal braking mode take place in an automated manner and typically independently of an actuation of the brake pedal by the driver. Such automated regulations of the wheel brake pressure take place, for example, in association with anti-slip regulation, which prevents individual wheels from spinning during a starting procedure via targeted braking, driving dynamics regulation in a narrower sense, which adapts the vehicle behavior in the limit range to the driver request and the roadway conditions via targeted braking of individual wheels, or adaptive cruise control, which, amongst other things, maintains a distance between the vehicle in question and a vehicle in front via automatic braking.

When executing automatic hydraulic pressure regulation, a hydraulic pressure can be built up on at least one of the wheel brakes 130A or 130B by controlling the hydraulic pressure generator 160. In this case, the valve arrangements 230, 240 or 250, 260 associated with the wheel brakes 130B, 130A hydraulic pressure generator 160 firstly assume their basic positions shown in FIG. 1. Fine adjustment or modulation of the hydraulic pressure can be undertaken by controlling the hydraulic pressure generator 160 and the valves 230, 240 or 250, 260 associated with the wheel brakes 130B or 130A accordingly, as explained by way of example above in association with the ABS regulation.

The hydraulic pressure regulation takes place by means of the control device system 300 generally depending, on the one hand, on sensor-detected parameters (e.g. wheel speeds, yaw rate, lateral acceleration, etc.) describing the vehicle behavior and, on the other hand, sensor-detected parameters (e.g. actuation of the brake pedal, steering-wheel angle, etc.) describing the driver request, where present. A deceleration request by the driver can be identified, for example, by means of a position sensor, which is coupled to the brake pedal or an input element of the master cylinder 110A. As the measured variable describing the driver request, it is alternatively or additionally possible to use the brake pressure generated in the master cylinder 110A by the driver, which is then detected by means of the sensor 180A (and the corresponding sensor 180B associated with the brake circuit II.) and possibly plausibility-checked. The deceleration request can also be initiated by a system for autonomous or partially autonomous driving.

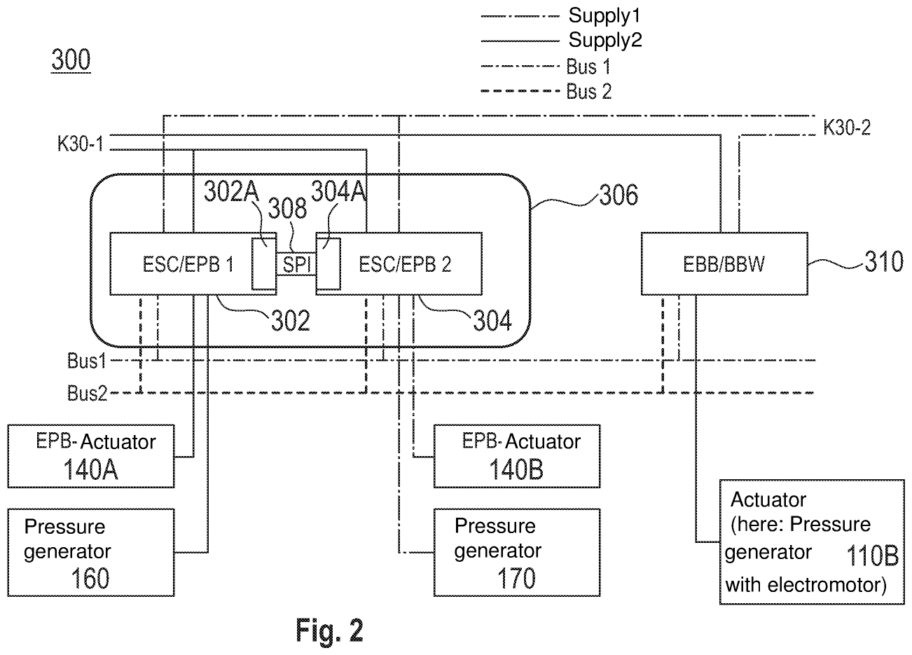

FIG. 2 shows an exemplary embodiment of the control device system 300 of FIG. 2. As shown in FIG. 2, the control device system 300 comprises a first control device 302, which is designed to control the hydraulic pressure generator 160 and the EPB actuator 140A, and a second control device 304, which is designed to control the hydraulic pressure generator 170 and the EPB actuator 140B. As explained in association with FIG. 1, this control can take place on the basis of a multiplicity of sensor-detected measured variables. In another exemplary embodiment, the two control devices 302 and 304 could also be combined to form a single control device, in particular in the case of a one-circuit configuration of the driving dynamics regulation system.

In the exemplary embodiment according to FIG. 2, the two control devices 302 and 304 are designed as a spatially cohesive control device unit 306. The two control devices 302 and 304 can therefore be accommodated in a common housing, but comprise separate processors 302A, 304A for processing the measured variables and for controlling the respectively associated components 140A, 160 and 140B, 170. For data exchange, for example in association with the plausibility-checking of measured variables and/or control signals, the corresponding processors 302A, 304A of the two control devices 302, 304 are communicatively connected to one another via a processor interface 308. The processor interface 308 in the exemplary embodiment is designed as a serial/parallel interface (SPI).

The control device system 300 further comprises a third control device 310, which is designed to control the hydraulic pressure generator 110B integrated in the assembly 310 and therefore, in particular, the electric motor thereof. Depending on the configuration of the brake system 100, this control can take place according to the EBB principle or the BBW principle. The control device 310 can form a spatially cohesive control device unit with the two other control devices 302 and 304, or it can be provided at a spacing from these. In one realization, a housing of the control device 310 is integrated in the assembly 110. In a system for autonomous or partially autonomous driving, the control device system can comprise a further control device (not illustrated in FIG. 2), which implements the corresponding functions.

As shown in FIG. 2, two parallel electric supply systems K30-1 and K30-2 are provided in the present exemplary embodiment (in other exemplary embodiments, in particular in a one-circuit configuration of the driving dynamics regulation system, only one of these supply systems K30-1 and K30-2 could be present). Each of these two supply systems K30-1 and K30-2 comprises a voltage source and associated voltage supply lines. In the exemplary embodiment according to FIG. 2, the supply system K30-1 is designed to supply the EPB actuator 140A and the hydraulic pressure generator 160, whilst the parallel supply system K30-2 is designed to supply the other EPB actuator 140B and the hydraulic pressure generator 170. In another exemplary embodiment, the EPB actuator 140A and the hydraulic pressure generator 160 could additionally (i.e. redundantly) be supplied by the supply system K30-2, and the EPB actuator 140B and the hydraulic pressure generator 170 could additionally be supplied by the supply system K30-1. The system redundancy is thus further increased.

Each of the three control devices 302, 304 and 310 (and an optional control device for autonomous or partially autonomous driving), is supplied redundantly both via the supply system K30-1 and via the supply system K30-2. To this end, each of the control devices 302, 304, 310 can be provided with two separate supply connections, which are each associated with one of the two supply systems K30-1 and K30-2.

As further shown in FIG. 2, two parallel communication systems Bus1 and Bus2 are provided redundantly, which, in the exemplary embodiment, are each designed as a vehicle bus (e.g. according to the CAN or LIN standard). The three control devices 302, 304 and 310 (and an optional control device for autonomous or partially autonomous driving) can communicate with one another via each of these two communication systems Bus1, Bus2. In another exemplary embodiment, only one bus system (e.g. Bus1) could be provided.

In the exemplary embodiment according to FIG. 2, the control of the components 140A, 160 and 140B, 170 takes place by means of the two control devices 302 and 304 and the control of the hydraulic pressure generator 110B integrated in the assembly 110 takes place by means of the control device 310 (or by means of the optional control device for autonomous or partially autonomous driving) in such a way that the corresponding control device 302, 304, 310 switches the power supply for the corresponding component on or off and possibly modulates it (e.g. via pulse-width modulation). In another exemplary embodiment, one or more of these components, in particular the EPB actuators 140A, 140B can be connected to one or both of the communication systems Bus1, Bus2. In this case, the control of these components by means of the associated control device 302, 304, 310 then takes place via the corresponding communication system Bus1, Bus2. In this case, the corresponding component can further be continuously connected to one or both of the supply systems K30-1, K30-2.

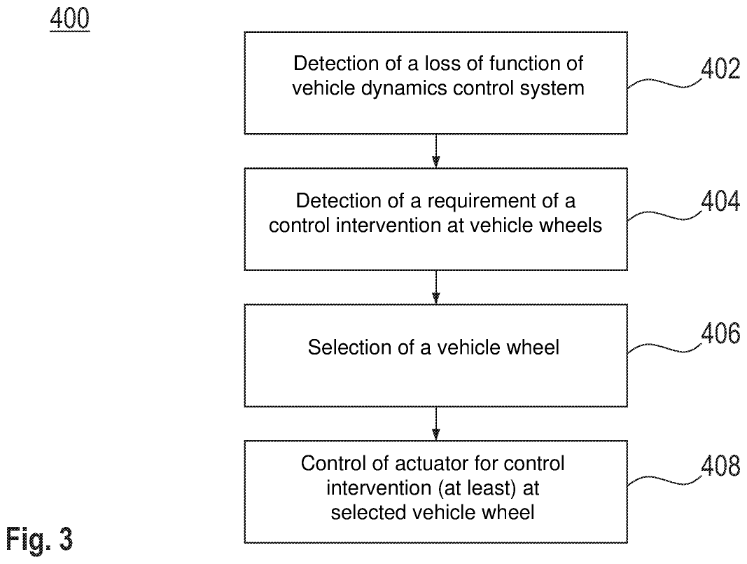

An exemplary embodiment of a method for operating the brake system 100 according to FIG. 1 is explained below with reference to the flow chart 400 according to FIG. 3. The method can be carried out by means of the control device system 300 illustrated in FIG. 2 or a control device system configured in another manner. In particular, the method (e.g. as a program code forming the basis of the method) can be implemented in the control device 310 and/or a control device (not illustrated in FIG. 2) for autonomous or partially autonomous driving.

The method begins in step 402 with the identification of a loss of function of the driving dynamics regulation system. For example, a loss of function (including a failure) of one of the two control devices 302, 304 (or both control devices 302, 304) can therefore be identified. A loss of function (including a failure) of one of the two (or both) hydraulic pressure generators 160, 170 can also be identified in step 402. It goes without saying that, in the case of a one-circuit driving dynamics regulation system, only one control device 302 or 304 and only one hydraulic pressure generator 160 or 170 will be present, which means that a loss of function thereof is all the more serious. The loss of function can be identified, for example, in that the corresponding control device 302, 304 no longer communicates at all or in that the corresponding control device 302, 304 communicates an error message. The error message can be attributed, for example, to the loss of function of one of the hydraulic pressure generators 160, 170 or one of the valves shown in FIG. 1.

After identifying the loss of function in step 402 (or previously or at the same time), it is identified in step 404 that a regulating intervention is required at two or more of the vehicle wheels VL, HR, VR, HL (c.f. FIG. 1). The identification of a regulating-intervention requirement at the respective wheel can take place by analyzing wheel signals (e.g. wheel speeds or wheel velocities). The wheel signals can be received by the control device 310, for example via the bus system Bus1. If available, further parameters can be additionally or alternatively used for recognizing the regulating-intervention requirement (e.g. yaw rate, steering angle, lateral acceleration and/or longitudinal acceleration). These further parameters can also be received, for example, via the bus system Bus1.

In step 404, a slip calculation is, in particular, carried out on the basis of the wheel signals. The slip calculation is based on the calculation of a deviation of an individual wheel velocity from the vehicle velocity. The vehicle velocity can be determined with the aid of the wheel velocity of a slip-free wheel or in another manner (e.g. on the basis of a satellite-based positioning system).

A roadway coefficient of friction for each wheel can further take place via the wheel velocities, the yaw rate or both in step 404 in order to identify a regulating-intervention requirement. It is thus possible, in particular, for different roadway coefficients of friction on different vehicle sides to be identified (i.e. a so-called split μ identification can be carried out). Vehicle stability identification (e.g. according to an ESP) can further be identified in step 404 based on the yaw rate (if available) in order to identify a regulating-intervention requirement.

As already mentioned, the steps 402 and 404 can be carried out in any order or also at the same time.

If, in step 404, a plurality of vehicle wheels are determined at which a regulating intervention is to be carried out (e.g. since it has been identified that a slip threshold value has been exceeded for a plurality of vehicle wheels), a selection of one of these vehicle wheels takes place in step 406. Specifically, the vehicle wheel selected is the one at which a regulating intervention promises the best results in terms of vehicle safety. The background to this selection is the fact that, with a loss of function of the driving dynamics regulation system, multi-channel regulating interventions are usually no longer possible. Multi-channel regulating interventions are understood to be those regulating interventions which take place at two or more vehicle wheels at the same time. However, the option of a one-channel regulating intervention by means of the actuator, which is conventionally used for (“one-channel”) service braking, is instead available. In the brake system according to FIG. 1, this is the hydraulic pressure generator 100B comprising the electric motor. Of course, in the driving dynamics regulation system according to FIG. 1, which is designed with two circuits, it may be that there is only a loss of function of one of the two regulating circuits, which means that the selection in step 406 can be restricted to the two vehicle wheels of the affected regulating circuit.

For more sustained regulation, the selection according to step 406 can be also be repeated once or a plurality of times in order to select different wheels in succession. However, it may also be that the selection in step 406 selects the same vehicle wheel a plurality of times.

After one of the affected vehicle wheels has been selected in step 406, control of the actuator, such as the hydraulic pressure generator 1006 according to FIG. 1, which comprises the electric motor, takes place in step 408 on the basis of a regulating intervention determined for the selected vehicle wheel. It should be pointed out that the regulating intervention determined for the selected vehicle wheel can also act on one or more vehicle wheels other than the selected vehicle wheel (or the associated wheel brake 130) since more than one wheel brake 130 can be fluidically coupled to the hydraulic pressure generator 1006. However, in this case, for example, locking of the non-selected wheel can be taken into account. If, for example, an anti-slip regulation intervention, which relates to the slip prevailing at the selected vehicle wheel, is carried out, the hydraulic pressure adjusted in this case by the actuator can lead to locking of one or more non-selected vehicle wheels (irrespective of whether a regulating intervention is even required there).

In the hydraulic brake system 100 according to FIG. 1, the regulating intervention can, in general, comprise hydraulic pressure regulation.

Several selection options according to step 406 and (one-channel) control options according to step 408 are listed in the table below. The slip and coefficient-of-friction recognition can be carried out on the basis of wheel signals. The regulating procedure can likewise be carried out on the basis of wheel signals. If one or more further parameters are available, for example the yaw rate, these can be taken into account both for the wheel selection and for the regulation.

| | | Selection/regulating |
|---|---|---|
| Identified situation | Strategy | intervention |
| Split μ, high coefficient- | Guiding wheels on right | Only the right high |
| of-friction side on the | side. If available, the | coefficient-of-friction wheels |
| right, e.g. identified via | stability observation via | are observed, wherein the |
| exceeded limit value | yaw rate can limit build- | high coefficient-of-friction |
| | up of brake pressure. | wheel with the greatest slip |
| | | is selected. If the yaw rate |
| | | is available, this is |
| | | additionally used for |
| | | pressure regulation in |
| | | relation to the right high- |
| | | coefficient-of-friction side. |
| | | Locking of individual, non- |
| | | selected wheels can be |
| | | accepted. |
| Split μ, high coefficient- | Guiding wheels on left | Only the left high |
| of-friction side on the left, | side. If available, the | coefficient-of-friction wheels |
| e.g. identified via | stability observation via | are observed, wherein the |
| exceeded limit value | yaw rate can limit build- | high coefficient-of-friction |
| | up of brake pressure | wheel with the greatest slip |
| | | is selected. If the yaw rate |
| | | is available, this is |
| | | additionally used for |
| | | pressure regulation of the |
| | | left high-coefficient-of- |
| | | friction side. Locking of |
| | | individual, non-selected |
| | | wheels can be accepted. |
| Homogeneous high | Deceleration regulation | Only the rear axle is |
| coefficient of friction μ, | via wheel pressure. | observed, wherein the |
| e.g. identified via | Regulation to target | coefficient-of-friction limit |
| comparison with high | deceleration e.g. 6 m/s². | should be prevented from |
| coefficient-of-friction limit | | being exceeded in a pre- |
| value | | controlled manner. To this |
| | | end, e.g. the rear wheel |
| | | which is closest to the |
| | | coefficient-of-friction limit is |
| | | selected (optionally |
| | | periodically or continuously). |
| | | Regulation takes place via |
| | | the vehicle deceleration. |
| | | Therefore, a further |
| | | increase in pressure upon |
| | | attaining e.g. 6 m/s² is |
| | | prevented. Locking of |
| | | individual non-selected |
| | | wheels can be accepted. |
| Homogeneous | Four-wheel “Select Low” | The wheel with the greatest |
| low/average coefficient of | regulation | slip pushes through. The slip |
| friction μ, e.g. identified | | component of all wheels is |
| via comparison with | | monitored so that a |
| suitable coefficient-of- | | coefficient-of-friction |
| friction limit value | | transition to split μ can be |
| | | identified (see above). If |
| | | individual wheels go into slip |
| | | too infrequently or never go |
| | | into slip, the slip phase and |
| | | slip depth of the regulated |
| | | wheel can be increased to |
| | | give the “too stable” wheels |
| | | a greater brake torque. |
| Oversteering identified | Guiding wheels are | Only the wheels on the |
| (yaw rate available) | wheels only on the inside | inside of the turn are |
| | of the turn or only rear | regulated in terms of slip, |
| | wheels. | wherein the wheel wheel |
| | | with the greatest slip on the |
| | | inside of the turn can be |
| | | selected. If desirable, the |
| | | strategy “only regulate the |
| | | rear wheels in terms of slip” |
| | | can be implemented and, |
| | | for example, the rear wheel |
| | | with the greatest slip can be |
| | | selected. As an option, the |
| | | attained minimum vehicle |
| | | deceleration is monitored |
| | | and the pressure regulation |
| | | is adapted to possibly |
| | | prevent underbraking. |
| | | Locking of individual non- |
| | | selected wheels can be |
| | | accepted. |
| Understeering identified | Guiding wheels are | Only the wheels on the |
| (yaw rate available) | wheels only on the | outside of the turn are |
| | outside of the turn or | regulated in terms of slip, |
| | only front wheels. | wherein the wheel wheel |
| | | with the greatest slip on the |
| | | outside of the turn can be |
| | | selected. If desirable, the |
| | | strategy “only regulate the |
| | | front wheels in terms of |
| | | slip” can be implemented |
| | | and, for example, the front |
| | | wheel with the greatest slip |
| | | can be selected. As an |
| | | option, the attained |
| | | minimum vehicle |
| | | deceleration is monitored |
| | | and the pressure regulation |
| | | is adapted to possibly |
| | | prevent underbraking. |
| | | Locking of individual non- |
| | | selected wheels can be |
| | | accepted. |

1. A motor vehicle brake system, comprising
a driving dynamics regulation system, which is designed to carry out a wheel-specific regulating intervention on each of a plurality of vehicle wheels;
an electrically controllable actuator, which is designed to generate or boost a service brake force; and
a control, which is designed, in the event of an identified loss of function of the driving dynamics regulation system,
to select one of at least two vehicle wheels on which a regulating intervention by the driving dynamics regulation system would be required; and
to electrically control the actuator on the basis of a regulating intervention determined for the selected vehicle wheel.

2. The brake system as claimed in claim 1, wherein
the control is designed to control the actuator on the basis of an anti-slip regulation intervention determined for the selected vehicle wheel.

3. The brake system as claimed in claim 1, wherein
the control is designed to select the vehicle wheel with the greatest slip.

4. The brake system as claimed claim 1, wherein
the control is designed to analyze roadway coefficients of friction associated with the vehicle wheels and to select the vehicle wheel on the basis of the roadway coefficient-of-friction analysis.

5. The brake system as claimed in claim 4, wherein the control is designed to determine a high coefficient-of-friction side of the vehicle on the basis of the roadway coefficient-of-friction analysis and to select the vehicle wheel with the greatest slip on the high coefficient-of-friction side.

6. The brake system as claimed in claim 4, wherein the control is designed, when the roadway coefficients of friction at all vehicle wheels are each below a threshold value, to select the vehicle wheel with the greatest slip.

7. The brake system as claimed in claim 4, wherein the control is designed, when the roadway coefficients of friction at all vehicle wheels are each above a threshold value, to select a rear wheel.

8. The brake system as claimed in claim 7, wherein the control is designed to carry out the regulating intervention on the selected rear wheel in such a way that, for the selected rear wheel, a coefficient-of-friction limit is prevented from being exceeded.

9. The brake system as claimed claim 1, wherein the control is designed to determine a yaw rate and to carry out at least one of the following steps:
select the vehicle wheel on the basis of the determined yaw rate; and
carry out the regulating intervention on the basis of the determined yaw rate.

10. The brake system as claimed in claim 9, wherein the control is designed to recognize oversteering on the basis of the yaw rate and to select a wheel on the inside of the turn or a rear wheel.

11. The brake system as claimed in claim 9, wherein the control is designed to determine understeering on the basis of the yaw rate and to select a wheel on the outside of the turn or a front wheel.

12. The brake system as claimed in claim 1, wherein the control is designed to also carry out the regulating intervention determined for the selected vehicle on at least one non-selected vehicle wheel.

13. The brake system as claimed in claim 12, wherein the control is designed, when carrying out the regulating intervention determined for the selected vehicle wheel on the at least one non-selected vehicle wheel, to permit locking of the at least one non-selected vehicle wheel.

14. The brake system as claimed in claim 1, wherein the control is designed to identify a regulating-intervention requirement at each of the at least two vehicle wheels.

15. The brake system as claimed in claim 14, wherein the control is designed to identify the regulating-intervention requirement on the basis of slip recognition for the respective vehicle wheel.

16. The brake system as claimed in claim 14, wherein the control is designed to identify the regulating-intervention requirement on the basis of at least one parameter measured at the respective vehicle wheel.

17. The brake system as claimed in claim 14, wherein the control is designed to identify the regulating-intervention requirement on the basis of at least one of the following parameters: yaw rate, steering angle, lateral acceleration, longitudinal acceleration, wheel speed, wheel velocity.

18. The brake system as claimed in claim 1, wherein the control is designed to identify the loss of function of the driving dynamics regulation system.

19. The brake system as claimed in claim 1, wherein the brake system further comprises at least one first control device, which is associated with the driving dynamics regulation system, and a second control device, which is associated with the electrically controllable actuator, wherein the control is implemented in the second control device and wherein the second control device is a control device for an electric brake booster or for a brake-by-wire system or for autonomous or partially autonomous driving.

20. (canceled)

21. A method for operating a motor vehicle brake system having a driving dynamics regulation system, which is designed for carrying out a wheel-specific regulating intervention on each of a plurality of vehicle wheels, and an electrically controllable actuator, which is designed to generate or boost a brake force, wherein the method, in the event of an identified loss of function of the driving dynamics regulation system, comprises:
selecting one of at least two vehicle wheels on which a regulating intervention by the driving dynamics regulation system would be required in each case; and
electrically controlling the actuator on the basis of a regulating intervention determined for the selected vehicle wheel.

22. (canceled)
